(19) United States
(12) Patent Application Publication
(10) Pub. No.: US 2010/0078416 A1
(43) Pub. Date: Apr. 1, 2010

(54) METHOD OF LASER MICRO-MACHINING STAINLESS STEEL WITH HIGH COSMETIC QUALITY

(75) Inventors: Weisheng LEI, Portland, OR (US); Hisashi MATSUMOTO, Portland, OR (US); Guangyu LI, Portland, OR (US); Jeff HOWERTON, Portland, OR (US)

Correspondence Address: Electro Scientific Industries Inc.;c/o Young Basile Hanlon & MacFarlane, P.C., 3001 West Big Beaver Rd., Ste. 624, Troy, MI, 48084, US

(73) Assignee: ELECTRO SCIENTIFIC INDUSTRIES, Portland, OR (US)

(21) Appl. No.: 12/238,995

(22) Filed: Sep. 26, 2008

(51) Int. Cl. B23K 26/00

(52) U.S. Cl. 219/121.72

(57) ABSTRACT

A process to laser micro-machine a metal part with a high cosmetic quality surface, including applying a protective coating layer to at least one surface of the part to physically isolate the surface from air prior to micro-machining the part with a laser, and sacrificing the protective layer to block/consume oxygen in air by carbonization and oxidation due to strong laser irradiation. The protective coating applied to at least one of a front side high quality cosmetic surface and a back side surface of the part. The coating layer being highly transparent to an applied laser beam, having a thickness of between approximately 5 mil and approximately 10 mil, inclusive, and having sufficient adhesion strength to adhere to the part without delaminating during processing. The laser can be selected from a nano-second pulse width laser and a micro-second pulse width laser to process the part.

### FIELD OF THE INVENTION

This invention provides a low-cost efficient way to maintain high cosmetic finish quality in laser micro-machining of consumer products made of stainless steels.

### BACKGROUND

For most consumer products, stainless steels are demanded to bear durable cosmetic finishes which are also endowed with superior performance characteristics including high levels of scratch resistance, easy-to-clean properties, resistance to discoloration, etc. Mechanical approaches have been used to make features such as apertures and slots without big concern on damaging the cosmetic finishes. As feature size gets smaller and smaller, laser micro-machining technologies are called in. When laser micro-machining technologies are applied to generate fine features on stainless steels bearing durable cosmetic finishes, due to the nature of thermal process for laser metal interaction, the cosmetic finishes can be easily damaged due to discoloration and delaminated due to oxidization and thermal stresses. Until today, laser micro-machining is still a relatively new technology as applied to stainless steels with an emphasis on cosmetic performance and little is published in this area.

### SUMMARY

In a process to laser micro-machine a metal part with a high cosmetic finish quality surface, the improvement according to one embodiment can include applying a protective coating layer to the high cosmetic finish quality surface of the metal part to physically isolate the surface from air prior to micro-machining the part with a laser.

In a process to laser micro-machine a stainless steel part with a high cosmetic quality surface, the improvement according to one embodiment of the invention can include applying a protective coating layer to at least one surface of the stainless steel part to physically isolate the surface from air prior to micro-machining the part with a laser, and sacrificing the protective layer to block/consume oxygen in air by carbonization and oxidation due to strong laser irradiation.

In a process to laser micro-machine a stainless steel part with a high cosmetic quality surface, the improvement according to one embodiment of the invention can include applying a protective coating layer to a front side high quality cosmetic surface and a back side surface of the stainless steel part to physically isolate the surface from air prior to micro-machining the part with a laser, the coating layer being highly transparent to an applied laser beam, the coating layer having a thickness of between approximately 5 mils and approximately 10 mils, inclusive, the coating layer having sufficient adhesion strength to adhere to the surface of the part without delaminating during handling and processing, sacrificing the protective layer to block/consume oxygen in air by carbonization and oxidation due to strong laser irradiation, and processing the part with a laser selected from a group consisting of a nano-second pulse width laser and a micro-second pulse width laser.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic view of a stainless steel part having a high quality cosmetic surface, a protective layer on at least one surface of the part, and a laser for micro-machining the part; and

FIG. 2 is a simplified process flow diagram illustrating an embodiment of the invention.

### DETAILED DESCRIPTION

The biggest challenge for using lasers to micro-machine stainless steels with cosmetic finishes is the discoloration surrounding the features being generated which makes the appearance of the consumer products totally unacceptable. The discoloration is believed to be due to the oxidization during the laser micro-machining process, which heats up the metal surfaces sufficiently to significantly enhance oxidization or nitridization of the metal surface with oxygen and nitrogen coming from the air. Although one can put the parts to be machined in vacuum or in a chamber filled with inert gases to isolate the parts from oxygen or nitrogen, or use a laser of extremely short pulse width, such as a ps- or fs-laser source, to significantly confine the thermal process, the cost can be very high and also very inconvenient.

One embodiment of the invention proposes to apply a protective coating layer on a cosmetic side of the metal part to physically isolate the part from the air during a laser micro-machining process. The protective coating layer can be also applied to a back side of the part, which receives the laser radiation to reduce debris and discoloration. In the case where an organic protective coating layer is applied, it also serves as a sacrificing layer to block/consume oxygen in air by carbonization and oxidization due to strong laser irradiation, even though the protective coating layer is relatively transparent to the laser beam under low intensity.

The protective coating layer can be an organic material such as adhesive polymers, or inorganic materials such as ceramic. The protective coating layer can be applied either in rigid form (by way of example and not limitation, such as a dry-film adhesive tape), or in liquid form (by way of example and not limitation, such as an adhesive, a wax, or thick resists). The protective coating layer can be applied via spin coating, or spraying, depending on the geometry of the part. Scotch tapes are a good example of a suitable protective coating layer. Transparent blue tape is used in the semiconductor industry to hold wafers, and is another good example of a suitable protective coating layer. In one embodiment, the coating layer should be highly transparent to the applied laser beam, provide sufficient adhesion strength with respect to the part, and have a thickness between approximately 5 mils and approximately 10 mils, inclusive. The process according to an embodiment of the present invention significantly relieves the requirements of a laser, such that a regular nano-second pulse width laser, or micro- second pulse width laser, will meet the requirements for the purpose of micro-machining metal parts with high quality cosmetic surface finishes. The process has been used to drill and cut stainless steel parts with cosmetic finishes in the lab and has proven to be successful. The process provides an easy, low cost, approach that does not demand an expensive short pulse width laser.

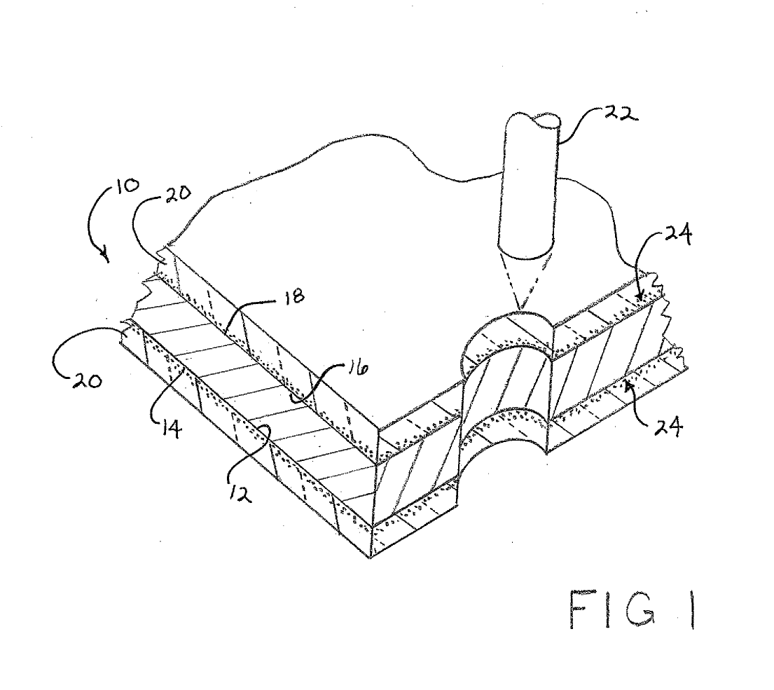

Referring to FIG. 1, a simplified schematic view of a metal part 10, by way of example and not limitation, such as a stainless steel part, is shown having a high quality cosmetic surface 12 on a first or front side 14 and another surface 16 on a second, rear, or back side 18. A protective coating layer 20 is located on at least one surface 12, 16 of the part 10. A laser 22 is used to micro-machine the part 10 with the protective coating layer 20. The protective coating layer 20 can be applied to the high cosmetic finish quality surface 12 of the part 10 to physically isolate the surface 12 from air prior to micro-machining the part 10 with the laser 22.

The protective coating layer 20 can be relatively transparent to a laser beam under low intensity from the laser 22. The protective coating layer can be an organic material, or inorganic material, serving as a sacrificing layer to block/consume oxygen in air by carbonization and oxidation due to strong laser irradiation. By way of example and not limitation, an organic material protective coating layer 20 can be an adhesive polymer. By way of example and not limitation, an inorganic material protective coating layer 20 can be a ceramic material.

The protective coating layer 20 can be applied to the part 10 in a variety of ways depending on the processing costs for a particular part geometry. By way of example and not limitation, the protective coating layer 20 can be applied in a rigid dry form, such as a dry film adhesive tape, or can be applied in a liquid form. The dry film adhesive tape protective coating layer 20 can be selected from a group consisting of a clear adhesive tape, a transparent blue adhesive tape, and any combination thereof. By way of example and not limitation, a liquid form protective coating layer 20 can be selected from a group consisting of an adhesive, a wax, a thick resist, and any combination thereof. The protective coating layer 20 can be applied via an application process selected from a group consisting of spin coating, spraying, and any combination thereof. The protective coating layer 20 is highly transparent to an applied laser beam from the laser 22. The protective coating layer 20 can have a thickness of between approximately 5 mils and approximately 10 mils, inclusive. The protective coating layer 20 can have inherent adhesive properties, or an additional adhesive interface 24, with sufficient adhesion strength to adhere to the part 10 without delaminating during processing. The protective coating layer 20 can be applied to the back surface 16 on the rear side 18 of the part 10, which receives the laser radiation from the laser 22 to reduce debris and discoloration. The laser 22 for micro-machining the part 10 can be selected from a group consisting of a nano-second pulse width laser and a micro-second pulse width laser.

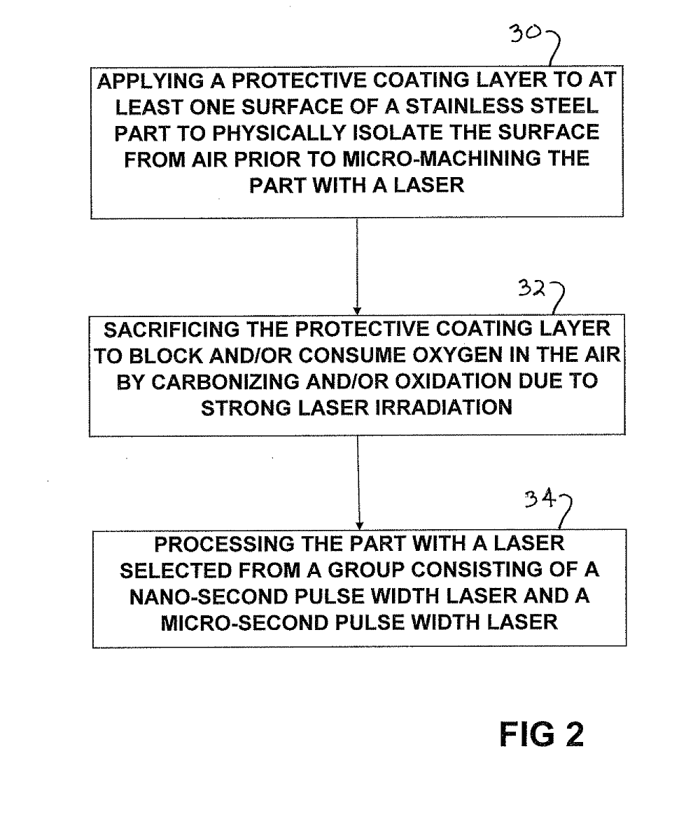

Referring now to FIG. 2, a simplified process diagram is illustrated. A process according to one embodiment of the present invention can include one or more of the process steps illustrated. By way of example and not limitation, the process can include applying a protective coating layer 20 to at least one surface 12, 16 of a stainless steel part 10 to physically isolate the surface 12, 16 from air prior to micro-machining the part 10 with a laser 22 as illustrated in process box 30. The protective coating layer 20 can be sacrificed to block and/or consume oxygen in the air by carbonizing and/or oxidation due to strong laser irradiation as illustrated in process box 32. The part 10 can be processed with a laser 22 selected from a group consisting of a nano-second pulse width laser 20 and a micro-second pulse width laser 22 as illustrated in process box 34.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a process to laser micro-machine a metal part with a high cosmetic finish quality surface, the improvement comprising:
applying a protective coating layer to the high cosmetic finish quality surface of the metal part to physically isolate the surface from air prior to micro-machining the part with a laser.

2. The process of claim 1, wherein the protective coating layer is an organic material serving as a sacrificing layer to block/consume oxygen in air by carbonization and oxidation due to strong laser irradiation.

3. The process of claim 2, wherein the organic material is an adhesive polymer.

4. The process of claim 1, wherein the protective coating layer is an inorganic material to serve as a sacrificing layer to block/consume oxygen in air by carbonization and oxidation due to strong laser irradiation.

5. The process of claim 4, wherein the inorganic material is a ceramic.

6. The process of claim 1, wherein the protective coating layer is applied in a rigid dry form.

7. The process of claim 6, wherein the rigid dry form is a dry film adhesive tape.

8. The process of claim 1, wherein the protective coating layer is applied in liquid form.

9. The process of claim 8, wherein the liquid form is selected from a group consisting of an adhesive, a wax, a thick resist, and any combination thereof.

10. The process of claim 1, wherein the protective coating layer is applied via an application process selected from a group consisting of spin coating, spraying, and any combination thereof.

11. The process of claim 1, wherein the protective coating layer is applied to a second side of the part, which receives radiation from a laser to reduce debris and discoloration.

12. The process of claim 1, wherein the protective coating is relatively transparent to a laser beam under low intensity.

13. The process of claim 1, wherein the protective coating layer is selected from a group consisting of a clear adhesive tape, a transparent blue adhesive tape, and any combination thereof.

14. The process of claim 1, wherein the protective coating layer is highly transparent to an applied laser beam, has a thickness of between approximately 5 mil and approximately 10 mil, inclusive, and has sufficient adhesion strength to adhere to the part without delaminating during processing.

15. The process of claim 1, wherein the laser can be selected from a group consisting of a nano-second pulse width laser and a micro-second pulse width laser to process the part.

16. In a process to laser micro-machine a stainless steel part with a high cosmetic quality surface, the improvement comprising:
applying a protective coating layer to at least one surface of the stainless steel part to physically isolate the surface from air prior to micro-machining the part with a laser; and
sacrificing the protective layer to block/consume oxygen in air by carbonization and oxidation due to strong laser irradiation.

17. The process of claim 16, wherein the protective coating is applied to a front side high quality cosmetic surface and a back side surface of the part.

18. The process of claim 16, wherein the coating layer is highly transparent to an applied laser beam, has a thickness of between approximately 5 mil and approximately 10 mil, inclusive, and has sufficient adhesion strength to adhere to the part without delaminating during processing.

19. The process of claim 16, wherein the laser can be selected from a group consisting of a nano-second pulse width laser and a micro-second pulse width laser to process the part.

20. In a process to laser micro-machine a stainless steel part with a high cosmetic quality surface, the improvement comprising:
applying a protective coating layer to a front side high quality cosmetic surface and a back side surface of the stainless steel part to physically isolate the surface from air prior to micro-machining the part with a laser, the coating layer being highly transparent to an applied laser beam, the coating layer having a thickness of between approximately 5 mils and approximately 10 mils, inclusive, the coating layer having sufficient adhesion strength to adhere to the surface of the part without delaminating during handling and processing;
sacrificing the protective layer to block/consume oxygen in air by carbonization and oxidation due to strong laser irradiation; and
processing the part with a laser selected from a group consisting of a nano-second pulse width laser and a micro-second pulse width laser.
